(19) United States
(12) Patent Application Publication
(10) Pub. No.: US 2026/0265088 A1
(43) Pub. Date: Sep. 10, 2026

(54) PULSED CORONA DISCHARGE-DRIVEN WATER TREATMENT WITH IMPROVED ENERGY EFFICIENCY

(71) Applicant: Fidchem, S.L., Tarragona (ES)

(72) Inventors: Oleg Dubov, Torredembarra (ES); Oleg Samsonov, Tarragona (ES)

(21) Appl. No.: 19/556,154

(22) Filed: Mar. 4, 2026

Related U.S. Application Data
(60) Provisional application No. 63/768,473, filed on Mar. 7, 2025.

(51) Int. Cl. C02F 1/46; B01J 19/08; C02F 1/461; C02F 101/20; C02F 101/36

(52) U.S. Cl. CPC C02F 1/4608; B01J 19/088; B01J 2219/0835; B01J 2219/0849; B01J 2219/0877; C02F 2001/46128; C02F 2101/20; C02F 2101/36; C02F 2201/46175; C02F 2201/4619

(57) ABSTRACT

A method and system for treating contaminated liquid. A method includes providing a discharge cell having a first group of parallel electrodes and a second group of parallel electrodes arranged in a crisscrossed manner to provide a discharge zone; filling the discharge cell with a reducing gas that includes at least one reductive gas selected from a group consisting of hydrogen, a gaseous organic compound, a vapour of a volatile organic compound, carbon monoxide, ammonia, hydrazine, and hydrogen sulfide; applying high voltage bipolar pulses to the first group of electrodes and second group of electrodes in the discharge cell to generate a plasma environment within the discharge zone; and introducing contaminated liquid into the discharge zone and subjecting the contaminated liquid to the plasma environment to reduce at least one of persistent organic compounds or reducible inorganic compounds.

### PRIORITY CLAIM

This application claims priority to co-pending provisional application 63/768,473 filed on Mar. 7, 2025, entitled METHOD OF PULSED CORONA DISCHARGE-DRIVEN WATER TREATMENT WITH IMPROVED ENERGY EFFICIENCY, the contents of which are hereby incorporated by reference.

### TECHNICAL FIELD

The present invention pertains to the field of water treatment and, more specifically, to a system for the elimination of persistent organic and inorganic contaminants, including fluorinated, chlorinated, and brominated compounds, oxygen-containing organic compounds and inorganic ions, from water sources.

### BACKGROUND

Water contamination due to the presence of persistent organic and inorganic contaminants, such as perfluorinated compounds or arsenate, poses significant challenges to both human health and the environment. These compounds are known for their resistance to conventional water treatment methods, making their removal a complex and pressing concern. Existing water treatment technologies often struggle to effectively remove these contaminants, leading to their persistence in water supplies. Consequently, there is a critical need for an innovative and efficient approach to address this issue.

### SUMMARY

The present invention relates to methods and apparatuses for treating and purifying liquids, including high-conductivity liquids by utilizing corona discharge. In certain aspects, the invention addresses the adverse effect of electrostatic coalescence of liquid droplets during plasma-assisted treatment, and proposes electrode configurations and pulse power strategies to improve energy efficiency and treatment effectiveness. In certain aspects, approaches include oxidative treatment, sterilization, and reductive processing of aqueous solutions, including those with high salt content or extreme pH values.

In one aspect, a method for treating contaminated liquid is provided that includes: providing a discharge cell having a first group of parallel electrodes and a second group of parallel electrodes arranged in a crisscrossed manner to provide a discharge zone; filling the discharge cell with a reducing gas that includes at least one reductive gas selected from a group consisting of hydrogen, a gaseous organic compound, a vapour of a volatile organic compound, carbon monoxide, ammonia, hydrazine, and hydrogen sulfide; applying high voltage bipolar pulses to the first group of parallel electrodes and second group of parallel electrodes in the discharge cell to generate to generate a pulsed corona discharge within the discharge zone; and introducing contaminated liquid into the discharge zone and subjecting the contaminated liquid to the plasma environment to reduce at least one of a persistent organic compound or a reducible inorganic compound.

In a further aspect, a system for treating contaminated liquid is provided that includes: a discharge cell having a first group of parallel electrodes and a second group of parallel electrodes arranged in a crisscrossed manner to provide a discharge zone; a system for introducing a reducing gas into the discharge cell, wherein the reducing gas includes at least one reductive gas selected from a group consisting of hydrogen, a gaseous organic compound, a vapour of a volatile organic compound, carbon monoxide, ammonia, hydrazine and hydrogen sulfide; a high voltage generator configured to apply high voltage bipolar pulses to the first group of parallel electrodes and second group of parallel electrodes in the discharge cell to generate a pulsed corona discharge within the discharge zone; and an inlet for introducing contaminated water into the discharge zone and subjecting the contaminated water to the plasma environment to reduce at least one of a persistent organic compound or a reducible inorganic compound.

Other aspects may be combined with the above and/or with each other. Such aspects may include wherein the first group of parallel electrodes and second group of parallel electrodes receive alternating positive and negative charges, respectively; wherein the first group of parallel electrodes and second group of parallel electrodes are arranged perpendicular to each other; wherein the first group of parallel electrodes and second group of parallel electrodes are interlaced about each other; wherein the high voltage bipolar pulses have a duration of between 10 and 50 nanoseconds; wherein at least one of the first group of parallel electrodes and second group of parallel electrodes have a metal core with a surface that includes a local curvature greater than the core; wherein the local curvature includes one of a brush-like profile or tufted profile; wherein the first group of parallel electrodes have the surface with local curvature greater than the core and the second group of parallel electrodes comprise a flat profile; wherein the reducing gas further includes a non-reductive gas selected from a group consisting of nitrogen, carbon dioxide, oxygen, argon, helium, or another noble gas; wherein the persistent organic compounds include at least one of fluorinated, chlorinated, and brominated compounds; wherein the contaminated liquid is introduced using at least one of showering, pulverizing, or a free-flowing film; wherein the discharge cell includes a dielectric barrier between the first group of parallel electrodes and second group of parallel electrodes; and/or wherein the contaminated liquid is passed through the discharge cell in one of a recirculated process, a continuous process and a batch process.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 depicts a water decontamination system, in accordance with an illustrative embodiment.

FIG. 2a depicts an electrode with a brush like profile, according to embodiments.

FIG. 2b depicts an electrode with a tufted profile, according to embodiments.

FIG. 2c depicts an electrode with a flat profile, according to embodiments.

FIG. 3 depicts a discharge cell with a first electrode arrangement, in accordance with an illustrative embodiment.

The drawings are intended to depict only typical aspects of the disclosure, and therefore should not be considered as limiting the scope of the disclosure.

### DETAILED DESCRIPTION

The present invention pertains to the field of water treatment and, more specifically, to a system for the elimination of persistent organic and inorganic contaminants, including fluorinated, chlorinated, and brominated compounds, oxygen-containing organic compounds and inorganic ions, from water sources. The invention utilizes plasma-assisted technology to achieve efficient removal of these contaminants, contributing to the improvement of water quality and environmental sustainability.

Existing plasma treatment systems for liquid purification utilize predominantly positive ions which impart a positive charge on the water droplets. Consequently, these droplets are electrostatically attracted to the negatively charged (typically grounded) flat electrodes, leading to droplet coalescence. The resulting formation of larger droplets or liquid films drastically reduces the total surface area available for plasma interaction, thereby lowering the efficiency of oxidation and other chemical processes. Previous attempts to increase the effective contact surface by employing mechanical, ultrasonic, or electrostatic atomization have proven ineffective due to persistent coalescence phenomena. Prior art examples include, e.g., PCT application, WO2014188078A1 (FI125772B), entitled, “Method and Device for a Liquid Purifying and Use of Device,” published on Nov. 27, 2014, which is hereby incorporated by reference.

The present aspects overcome the limitations inherent in the prior art by mitigating the effect of electrostatic coalescence through various approaches, which may be employed individually or in combination.

In one approach, an electrode configuration is utilized wherein alternating negative and positive electrodes are designed to provide an enhanced effective surface area. In one embodiment, an array of parallel wire electrodes are arranged in an alternating “chessboard” or interlaced configuration. In such an arrangement, each positively charged wire is predominantly surrounded by negatively charged wires and vice versa.

In a further aspect, the electrodes may be enhanced with local curvature, such as structures with brush-like or tufted profiles, which increase the available corona emission area, further increasing the energy efficiency.

In a second approach, a bipolar impulse power supply may be utilized, which generates alternating positive and negative voltage pulses into the array. The relative amplitudes and timing of these pulses are adjusted such that the electrostatic charging of droplets is neutralized, effectively compensating for the initial positive charging effect imparted by the corona plasma. This alternating polarity approach ensures that the net electrostatic forces on the droplets are minimized, thereby preventing the coalescence of fine droplets and preserving a high total surface area for plasma-liquid interaction.

In a further approach, the pulse duration of the high-voltage pulses may be significantly reduced, e.g., to a range of 10 to 50 nanoseconds. The shortened pulse duration minimizes the time available for charge accumulation on droplets, reducing electrostatic effects as well as ionic water conductivity effects and concomitant energy losses. This optional feature is particularly advantageous when treating highly saline water or water with extreme pH values, as it contributes to improved energy efficiency and process stability.

Additionally, it is recognized that in specific applications the otherwise deleterious effect of droplet coalescence may be harnessed advantageously. In one approach, the apparatus may incorporate an auxiliary aerosol disruption block. In particular, a corona discharge is ignited between electrodes, e.g., by providing highly curved positive elements and flat negative elements. The disruption can be driven by the electrostatic field (as opposed to the corona discharge), and therefore can occur anywhere in the whole volume between the electrodes with subsequent coalescence of liquid on the flat electrode. Such a configuration is thus optimized for the rapid breakup of fine aerosols, thereby facilitating the formation of a plasma-treated liquid phase with desirable properties.

Moreover, the various aspects provide versatility in the choice of discharge atmosphere. Unlike the prior art, which confines operation to an oxidizing (oxygen-enriched) medium, the present approaches allow corona discharges to be initiated in inert gases (e.g., nitrogen for sterilization) or reducing gases (to effect reductive removal of halogenated organics and certain inorganic compounds). These approaches are for example described in US Publication 2025/0250186 published on Aug. 7, 2025, entitled PLASMA-ASSISTED WATER TREATMENT SYSTEM FOR ELIMINATION OF PERSISTENT ORGANIC AND INORGANIC WATER CONTAMINANTS, the contents of which are hereby incorporated by reference.

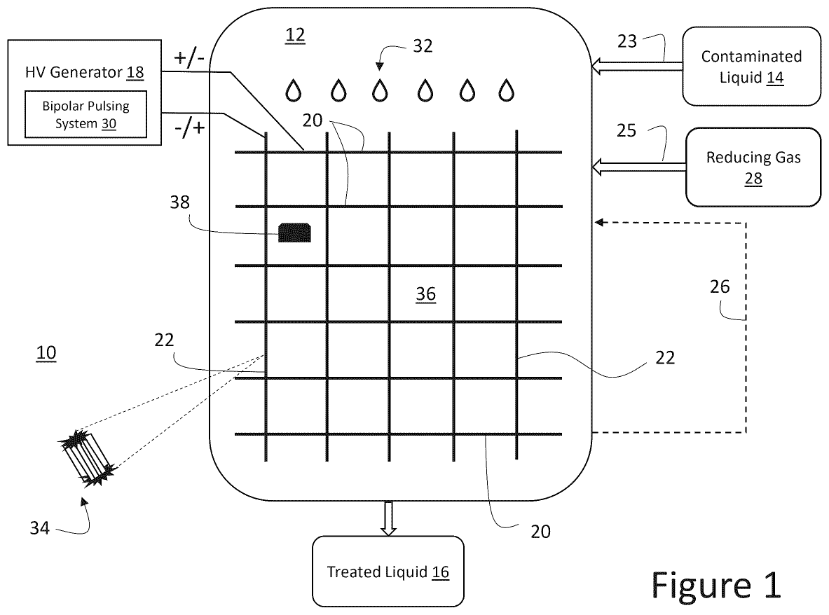

Referring now the drawings, FIG. 1 depicts an illustrative water decontamination system 10 configured to receive a source of contaminated liquid (e.g., water) 14 and output decontaminated or treated liquid 16. System 10 generally includes a discharge cell 12, a high voltage (HV) generator 18 having a bipolar pulsing system 30, and a source of reducing gas 28. Reducing gas 28 is introduced into discharge cell 12 via a gas inlet 25 such as a controllable valve, and for example includes one or more reductive gases or a mixture of one or more reductive gases and non-reductive gases. Reductive gases may for example include hydrogen, gaseous organic compounds or vapours of volatile organic compounds, carbon monoxide, ammonia, hydrazine, and hydrogen sulfide, and non-reductive gases may for example include nitrogen, carbon dioxide, oxygen, carbon dioxide, argon, helium, or another noble gas. Selective mixtures of the gases allow for a tailored plasma environment suitable for the degradation or modification of a wide range of organic compounds.

Once the discharge cell 12 is filled with the reducing gas 28, HV generator 18 is configured to apply high voltage bipolar pulses to a first group of parallel electrodes 20 and a second group of parallel electrodes 22, e.g., to generate a pulsed corona discharge within a discharge zone 36 in the discharge cell 12. In an illustrative embodiment, HV generator 18 outputs voltages in the range of several tens of kilovolts, with pulse durations ranging from nanoseconds to hundreds of nanoseconds and a typical pulse repetition rate in the kilohertz range for pulsed corona discharge. The first group of parallel electrodes 20 and second group of parallel electrodes 22 accordingly receive alternating positive and negative charges by the bipolar pulsing system 30, respectively. It is understood that the parameters of the pulsed high voltage generated by HV generator 18 can vary, e.g., to be optimized for efficient plasma generation.

In certain aspects, the first group of parallel electrodes 20 and second group of parallel electrodes 22 are arranged in a crisscrossed manner, e.g., in a checkerboard pattern or array perpendicular to each other. Although shown in a front facing (x-y axis) orientation within discharge cell 12, the pattern can also be oriented into/out of the page (i.e., along a z-axis). In other embodiments, the pattern can be arranged in tilted orientation. Further, although shown in a single layer, the electrode arrangement can include two or more layers of crisscrossed electrodes (not shown). In an illustrative configuration, the spacing between electrodes in the first group of parallel electrodes 20 and/or second group of parallel electrodes 22 can range from millimeters to centimeters, depending on the desired treatment efficiency. First and second groups of parallel electrodes 20, 22 may be overlayed (e.g., the arrangement may include a layer of horizontal electrodes separated by a layer of vertical electrodes) or interlaced about each other (e.g., horizontal electrodes may be “snaked” around vertical electrodes and vice versa). In still further embodiments, although shown forming a checkerboard pattern (i.e., square opening 36), first group of parallel electrodes 20 and second group of parallel electrodes 22 could be arranged to form non-square openings (e.g., rhombus or diamond shaped openings).

In certain embodiments, HV generator 18 includes a bipolar pulsing system 30 that generates alternating positive and negative voltage pulses. Bipolar pulsing system 30 may comprise a specialized power supply or generator that produces voltage pulses that alternately swing between positive and negative polarities. Unlike a unipolar system, which outputs only one polarity, a bipolar system delivers dual-polarity, e.g., square, or sine-wave pulses that pass through zero. The relative amplitudes and timings of these pulses can be adjusted such that the electrostatic charging of droplets 32 is neutralized, effectively compensating for the initial positive charging effect imparted by the corona plasma. In some embodiments, bipolar pulsing system 30 may use very short pulses, e.g., in a range of 10 to 50 nanoseconds.

The contaminated liquid 14 is introduced into the discharge cell 12, e.g., via a liquid inlet 23 such as a controllable valve, where it is treated by the generated pulsed corona discharge. Depending on the implementation, the liquid in the discharge cell 12 may be recirculated 26 to enhance the decontamination process (recirculated process). In other cases, decontamination may be implemented with a single pass in which the liquid is continuously introduced and expelled (continuous process). In other cases, decontamination may be implemented in a batch process, in which the cell 12 is filled and the liquid is processed for a period of time, then expelled (batch process). Accordingly, the contaminated liquid 14 can be passed through the discharge cell 12 using a continuous, recirculated, or batch process.

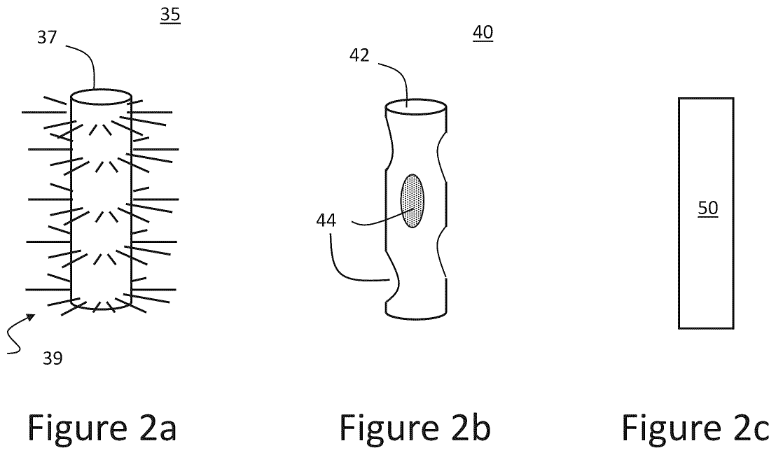

Electrodes 20, 22 may be implemented with any conductive material (i.e., metal) and have any cross-section, e.g., round, oval, geometric, etc. Furthermore, as noted, electrode surfaces may be implemented with high local curvature 34 (e.g., sharp points, edges, corners, highly convoluted surfaces, etc.) to achieve a reduction in effective surface area compared to flat or mesh electrodes. FIGS. 2a and 2b show portions of illustrative electrodes 35, 40 with high local curvature. For example, FIG. 2a show an electrode 35 with a metal core 37 (e.g., wire) having a surface with brush-like projections 39 emanating therefrom. In this case, the local curvature of the brush-like projections 39 is greater than the curvature of the core. FIG. 2b shows a further electrode 40 having metal core 42 with “tufts” 44 cut into the surface, i.e., the local curvature of tufted surface is greater than the curvature of the core 42. It is understood that any profile that provides a local curvature greater that a typical smooth electrode surface could be utilized, e.g., needle-like structures, ribbed structures, textured structures, angled structures, braided structures, etc.

FIG. 2c depicts a flat electrode 50. As noted, in certain embodiments, a corona discharge block can be implemented and ignited between electrodes comprising highly curved electrodes (e.g., electrodes 35 or 40) and flat electrodes (e.g., electrode 50). Such a configuration is optimized for the rapid breakup of fine aerosols, thereby facilitating the formation of a plasma-treated liquid phase with desirable properties.

Furthermore, the discharge cell 12 can optionally include an electrically insulating material 38 between the first and second groups of electrodes 20, 22. Insulating material can for example comprise a dielectric material such as glass, quartz, ceramics, and polymers. The dielectric can reside in any location, e.g., in the openings between the first and second group of electrodes, between the area where the electrodes crisscross, etc. It is understood that the size, arrangement, and number of electrodes 20, 22, as well as any insulating material, can vary depending on the particular implementation.

Once the plasma (i.e., pulsed) discharge is created, contaminated liquid 14 is introduced into the discharge cell 12. Introduction may for example be at a low pressure and comprise droplets 24 by showering, pulverizing or as a free-flowing film on electrodes 20, 22 or the insulating barrier material.

Depending on the type of reducing gas 28 being used, discharge cell 12 may or may not include a gas output. For example, if the gas consists solely of hydrogen, gas output may not be required since the hydrogen will be consumed as part of the process.

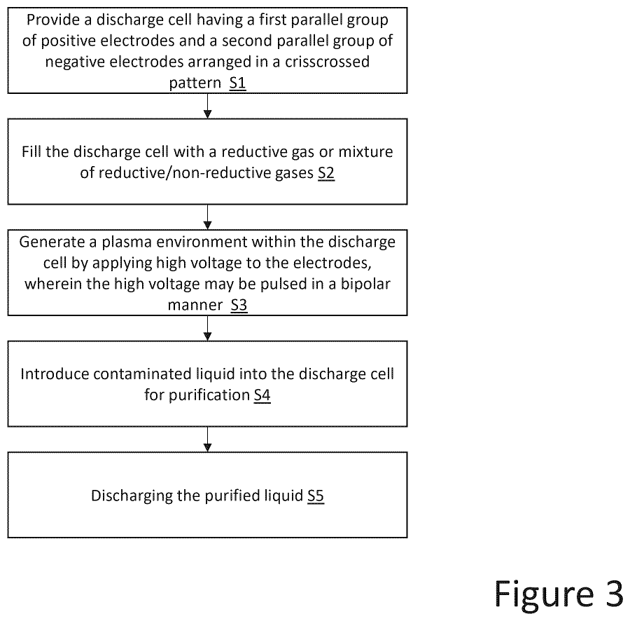

FIG. 3 depicts a flow diagram of an overview of the process. At S1, a discharge cell is provided having a first parallel group of electrodes and a second parallel group of electrodes arranged in a crisscrossed pattern. Next, at S2, the discharge cell is filled with a reducing gas, e.g., a reductive gas or a mixture of reductive/non-reductive gases. Reductive gases may for example include hydrogen, gaseous organic compounds or vapours of volatile organic compounds, carbon monoxide, ammonia, hydrazine and hydrogen sulfide, and non-reductive gases may for example include nitrogen, carbon dioxide, noble gases, and small amounts of oxygen. At S3, a plasma environment within the discharge cell is generated by applying high voltage to the electrodes. In certain cases, the voltage includes bipolar pulses. At S4 contaminated liquid is introduced into the cell for purification. At S5, the treated liquid is discharged.

These various aspects address aforementioned challenges by introducing a novel plasma-assisted system and method based on excitation of non-thermal plasmas, preferably pulsed corona discharge (PCD) in a reducing atmosphere, e.g., a hydrogen-rich atmosphere, providing direct contact of treated liquid with cold plasma. The species generated in plasmas include free electrons, that can be directly transferred to aqueous solutions via gas-liquid interface and act as powerful reducing agents. However, the presence of a significant amount of oxygen in the plasma carrier gas drastically reduces the generation of electrons due to their scavenging by oxygen-containing species. In contrast, the presence of a reducing gas in the plasma media can increase the generation of free electrons. Moreover, electric discharges in hydrogen-rich atmosphere are known to generate short-lived atomic hydrogen, which is also transformed to solvated electrons upon contact with water. The dissolved electrons realize the reductive activity and eliminate halogens from polyfluorinated compounds, resulting in the formation of aliphatic and aromatic hydrocarbons and inorganic fluoride. It should be noted that reductive plasma conditions can frequently be established within non-oxidizing carrier gases, even in the absence of an intrinsic reductive gas component. For example, the processing of aqueous solutions containing organic compounds with argon plasma frequently culminates in the in-situ generation of hydrogen. In certain approaches, an imperative is to ensure an environment with the prevalence of reductive species to facilitate effective plasma-induced reduction, rather than the obligatory introduction of reductive gases per se. However, for most practical uses, the introduction of a reductive gas to the plasma gas mixture may be preferred. It should also be noted that, in the presence of a reductive gas like hydrogen, small amounts of oxygen can counterintuitively increase the efficiency of reductive plasmas by facilitating a two-step reduction-oxidation mechanism, starting from contaminant reduction with atomic hydrogen or dissolved electrons (for instance, halogen abstraction in the case of halogenated pollutants), followed by an oxidation step, resulting in the formation of less halogenated or non-halogenated aldehydes and ketones.

In cases where oxygen is utilized, care must be taken as oxygen and hydrogen and other reductive gases become explosive when they coexist in high concentrations. Accordingly, in cases involving a binary mixture, e.g., hydrogen with oxygen, the system remains operative (i.e., safe) so long as the oxygen is below half of the hydrogen's content by volume. The same applies to other reductive gases with the corresponding application of their stoichiometry coefficients for the reaction with oxygen. Thus, for example, the content of hydrogen in volume percentage (e.g., 2%) should be at least double of the oxygen's content (e.g., 1%), while the oxygen's content should not exceed 2% to ensure explosion safety.

The utilization of a reducing gas like hydrogen in plasma-based treatment has been limited to the context of gas phase reactions or surface treatments, rather than liquid phase water treatment. The present approach capitalizes on this gap by enabling efficient electron transfer to the aqueous phase, which significantly enhances the reductive dehalogenation process.

The present embodiments are not restricted solely to oxidative treatments. The discharge atmosphere may be selected according to the desired chemical reaction. For instance, an inert atmosphere (such as nitrogen) may be used for sterilization applications, while a reducing gas atmosphere may be employed for the reductive dehalogenation of organic compounds and certain inorganic constituents.

The synergy between the pulsed corona discharge and the intrinsically reductive atmosphere provides a previously untapped mechanism for the breakdown of resistant organic and inorganic compounds, offering a new paradigm in advanced reduction 'rocesses for water treatment.

The plasma technology proposed in the present approach ensures a more efficient and targeted production of solvated electrons using non-thermal plasma in a reductive atmosphere. This approach not only reduces energy expenditure compared to ultrasonic processing but also achieves a higher level of electron generation, which potentially increases the efficacy of the reduction of recalcitrant compounds. Thus, the current approach provides new opportunities for purifying water sources of persistent halogenated and some non-halogenated organic contaminants, as well as free and coordinated ions of metals and non-metals, expanding the capabilities of existing methods and offering a more advanced solution to this environmental challenge.

An additional significant advantage of the present approach lies in its tolerance to liquid input with a high load of mechanical impurities. Commonly, wastewater streams, such as landfill leachate, heavily laden with polyhalogenated impurities, also carry substantial amounts of clay and other mechanical contaminants. Conventional plasma treatment systems that depend on fine aerosolization of the liquid require stringent pre-filtration to prevent clogging and maintain efficiency, which adds to the complexity and cost of the treatment process. In stark contrast, the present system's robust design permits the direct introduction of such contaminated streams, using large droplets or films, without the need or with minimal need for pre-filtration. This not only simplifies the overall treatment process but also significantly reduces the cost and time associated with pre-treatment steps. The capability to handle unfiltered and highly contaminated liquids directly translates to a broader applicability in real-world environmental clean-up scenarios, where the complexity and variability of waste streams can otherwise be a limiting factor.

A further feature of this approach involves the use of plasma to efficiently reduce fluorinated, chlorinated, or brominated compounds, as well as some other classes of highly oxidized organic compounds (e.g. carboxylic acids, aldehydes, ketones) and inorganic compounds (heavy metals and nonmetals in ionic form) leading to their degradation and removal from the water source. This innovative approach accordingly offers a promising solution for the remediation of water contaminated with persistent organic and inorganic compounds, thereby contributing to improved water quality and environmental sustainability. The approach allows for contaminated water to be treated to levels compliant with established water quality standards.

System 10 accordingly provides a plasma-assisted reduction process that can result in the complete elimination of fluorinated, chlorinated, and brominated organic compounds from the contaminated liquid 14, as well as the elimination of reducible inorganic compounds from the contaminated liquid 14. In other cases, the plasma-assisted reduction process can reduce the concentration of fluorinated, chlorinated, and brominated organic compounds, as well as some oxygen and nitrogen-containing compounds and reducible inorganic compounds in the contaminated liquid 14 to levels compliant with established water quality standards.

This approach accordingly utilizes a plasma environment to efficiently reduce fluorinated, chlorinated, and brominated organic compounds present in the contaminated liquid 14, as well as some oxygen and nitrogen-containing organic compounds and some inorganic compounds such as heavy metal ions. When subjected to the plasma environment created within the discharge cell, the persistent organic contaminants undergo chemical reactions, leading to their degradation and eventual elimination. In the case of inorganic contaminants, they are typically reduced to form elemental powders and can be subsequently removed by filtration. It is important to note that the capability for removal of organic compounds is not limited to halogen-containing compounds only, some non-halogenated organic compounds can undergo chemical transformation as well.

The invention described herein represents a significant advancement in the field of water treatment, specifically aimed at the elimination of persistent organic and toxic inorganic contaminants, including fluorinated, chlorinated, and brominated compounds, and heavy metals and non-metals ions, although not limited to these classes of contaminants. By harnessing the power of plasma within the discharge cell and optimizing various parameters, this technology offers an effective solution for the efficient removal of stubborn contaminants from water sources.

The innovative system described in this detailed description demonstrates the potential to greatly improve water quality, protect the environment, and contribute to the overall well-being of communities by ensuring access to safe and clean drinking water.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

1. A method for treating contaminated liquid, the method comprising:
providing a discharge cell having a first group of parallel electrodes and a second group of parallel electrodes arranged in a crisscrossed manner to provide a discharge zone;
filling the discharge cell with a reducing gas that includes at least one reductive gas selected from a group consisting of hydrogen, a gaseous organic compound, a vapour of a volatile organic compound, carbon monoxide, ammonia, hydrazine, and hydrogen sulfide;
applying high voltage bipolar pulses to the first group of parallel electrodes and second group of parallel electrodes in the discharge cell to generate a pulsed corona discharge within the discharge zone; and
introducing contaminated liquid into the discharge zone and subjecting the contaminated liquid to the pulsed corona discharge to reduce at least one of a persistent organic compound or a reducible inorganic compound.

2. The method of claim 1, wherein the first group of parallel electrodes and second group of parallel electrodes receive alternating positive and negative charges, respectively.

3. The method of claim 1, wherein the first group of parallel electrodes and second group of parallel electrodes are arranged perpendicular to each other.

4. The method of claim 1, wherein the first group of parallel electrodes and second group of parallel electrodes are interlaced about each other.

5. The method of claim 1, wherein the high voltage bipolar pulses have a duration of between 10 and 50 nanoseconds.

6. The method of claim 1, wherein at least one of the first group of parallel electrodes and second group of parallel electrodes have a metal core with a surface that includes a local curvature greater than the curvature of the core.

7. The method of claim 6, wherein the local curvature includes one of a brush-like profile or tufted profile.

8. The method of claim 6, wherein the first group of parallel electrodes have the surface with local curvature greater than the curvature of the core and the second group of parallel electrodes comprise a flat profile.

9. The method of claim 1, wherein the reducing gas further includes a non-reductive gas selected from a group consisting of nitrogen, carbon dioxide, oxygen, argon, helium, or another noble gas.

10. The method of claim 1, wherein the persistent organic compounds include at least one of fluorinated, chlorinated, and brominated compounds.

11. The method of claim 1, wherein the contaminated liquid is introduced using at least one of showering, pulverizing, or a free-flowing film.

12. The method of claim 1, wherein the discharge cell includes a dielectric barrier between the first group of parallel electrodes and second group of parallel electrodes.

13. The method of claim 1, wherein the contaminated liquid is passed through the discharge cell in one of a recirculated process, a continuous process, and a batch process.

14. A system for treating contaminated liquid, the comprising:
a discharge cell having a first group of parallel electrodes and a second group of parallel electrodes arranged in a crisscrossed manner to provide a discharge zone;
a gas inlet for introducing a reducing gas into the discharge cell, wherein the reducing gas includes at least one reductive gas selected from a group consisting of hydrogen, a gaseous organic compound, a vapour of a volatile organic compound, carbon monoxide, ammonia, hydrazine and hydrogen sulfide;
a high voltage generator configured to apply high voltage bipolar pulses to the first group of parallel electrodes and second group of parallel electrodes in the discharge cell to generate a pulsed corona discharge within the discharge zone; and
a liquid inlet for introducing contaminated liquid into the discharge zone and subjecting the contaminated liquid to the pulsed corona discharge to reduce at least one of a persistent organic compound or a reducible inorganic compound.

15. The system of claim 14, wherein the first group of parallel electrodes and second group of parallel electrodes receive alternating positive and negative charges, respectively.

16. The system of claim 14, wherein the first group of parallel electrodes and second group of parallel electrodes are arranged perpendicular to each other.

17. The system of claim 14, wherein the high voltage bipolar pulses have a duration of between 10 and 50 nanoseconds.

18. The system of claim 14, wherein at least one of the first group of parallel electrodes and second group of parallel electrodes have a metal core with a surface that includes a local curvature greater than the curvature of the core.

19. The system of claim 18, wherein the local curvature includes one of a brush-like profile or tufted profile.

20. The system of claim 18, wherein the first group of parallel electrodes have the surface with local curvature greater than the curvature of the core and the second group of electrodes comprise a flat profile.
